(19) United States
(12) Patent Application Publication
(10) Pub. No.: US 2017/0300304 A1
(43) Pub. Date: Oct. 19, 2017

(54) ENCAPSULATION SYSTEM FOR PROGRAMMING LANGUAGES

(71) Applicants: Omri Mark WEIL SHLOMO, Rehovot (IL); Ido KANNER, Ein Iron (IL)

(72) Inventors: Omri Mark WEIL SHLOMO, Rehovot (IL); Ido KANNER, Ein Iron (IL)

(21) Appl. No.: 15/515,993

(22) PCT Filed: Sep. 27, 2015
(86) PCT No.: PCT/IL2015/050979

§ 371 Date: Mar. 30, 2017

(30) Foreign Application Priority Data
Sep. 30, 2014 (IL) 234911

(51) Int. Cl. G06F 9/44; G06F 9/455; G06F 11/36

(52) U.S. Cl. CPC G06F 8/34; G06F 8/315; G06F 8/31; G06F 11/362; G06F 9/45533

(57) ABSTRACT

An adaptive self-modifying system for encapsulating programming languages using graphical objects. The encapsulation system is intuitively based and is suitable for non-qualified users. The encapsulation is written in an innovative and novel way, using a graph structure of flow charts describing the function performed.

### FIELD OF THE INVENTION

An adaptive self-modifying system for encapsulating programming languages using graphical objects. The encapsulation system is intuitively based and is suitable for non-qualified users. The encapsulation is written in an innovative and novel way, using a graph structure of flow charts describing the function performed.

### BACKGROUND OF THE INVENTION AND PRIOR ART

The encapsulation is based on the programming language that is requested to be visualized, and might contain not all the aspects as described in this document, but only those required by the original programming language.

The encapsulation is intuitively based and is suitable for non-qualified users. The encapsulation is performed using a graph structure of flow charts describing the function performed, and able to represent many types of requirements.

The encapsulation itself is done in a complete graphical environment that allows the creation, interpretation and debugging of an encapsulation solution

For example, a telecommunication program will have the following structure:

A non-technical user or one of non-logical skills will be able to use a kind of container charts of functions, as demonstrated in the above Dial-plan Component palette and the here under picture of the dragging IVR component.

The encapsulation consists of different levels providing users with tools fitted to their understanding abilities. For example, a technical user or one of logical skills will be able to use logic functions such as “if” notation, compound loop sentences and the likes.

The invention introduced in this application, when used on a specific system, can be platform independent. For example, for a telecommunication system, the components of a Dial-plan may be defined independently of a specific telephony switchboard type or any other related infrastructure, thus capable of suiting many types of telephony systems, and therefore, it introduces a new way to write code in the industry.

### SUMMARY OF INVENTION

The encapsulation of programming languages may be expanded by external modules, which actually encapsulate the original programming methods or functions meant for technical users with a graphic envelope to be used by the non-skilled user.

If an encapsulation is able to represent several encapsulated programming languages, the same higher level representation can be used to generate programs or interface with systems supporting those languages, independently of the encapsulated language that is used.

General explanations:
A connector is a kind of class which includes various behavior tables, like comparison ability, jumping tables and any other function needed for connection performance. Connectors have a base class that defines its abilities needed only by connectors.
A container is a specific class that includes objects taking care of the logistics of transit between all objects. A container is actually a kind of an execution object.
Code—The code behind an object can be written with the encapsulation interface or the programming language, provided that in the latter case, the programmer will define the encapsulation GUI that is attached to the specific code. In such case, the same GUI can be used with different programming languages that perform same function.
Byte Code—The system provides a virtual machine executing a byte code. The byte code translation of the object must also be provided for it. This allows the system to actually interpret the objects without translating the encapsulated code. The interpreter has Garbage Collection (GC) system and support for system calls.

Primary realization includes three encapsulation levels:
The high level enabling the performance of graphical functions for non-technical users, thus using predefined graphic objects linked by lines, describing the action flow like in a flowchart.
The low level enabling the performance of graphical logic functions for technical users, capable of following programming commands. The low level also uses graphic objects linked by lines, like in a flowchart.
API level enabling to run different commands with which objects or drawings are constructed for use in the highest levels.

The encapsulation requires the user to write only minimal text, such as function parameters.

Each specific target, when added to the basic encapsulation, comes with a significant set of basic libraries. For example, for the telecommunication field, libraries dealing with HTTP, FAX, SMTP, handling various Medias, working with databases in different configurations such as key value, document base, SQL and other types. Additionally, Regex evaluation and other basic libraries will also be provided. Those functions enable, for example, to create tools that report via REST, allowing for certain data to be retrieved when needed. Furthermore, in the low level it is possible to send and retrieve various variables as part of the flowchart.

Graphical expression to an API is automatically performed, but the realization of a suitable drawing has to be created by the API provider. Such realization, with user's input, is unique for the desired functionality.

The presentation of the encapsulation, has several ways to deal with data:
Variables—There are three types of variables:
   Local variable—a way to store data in a local container, whilst this data is unavailable outside of the specific container.
   Thread variable—a variable which exists as long as the thread exists. Once the function ability and performance of the thread is terminated, the variable ceases to exist. While in run, each thread will contain an independent instance of the variable.
   Global variable—a variable, either read-only or read & write, that is accessible in all stages of the program, and once changed, the new data is accessible to every part of the program that uses the variable.
Analysis functions—functions which are able to analyze received data:
   Analyzing text with REGEX—implementing different REGEX engines
   Analyzing variable contents
   Text comparison
   Time comparison
   Comparison of ranges of numbers
Copying of variable contents (from local container variable to thread variable, from thread variable to global variable etc.)
   Triggering event that is raised, the system will trigger a callback.
   Ability to terminate execution.
Performing of logical syntax & operations:
   “If” syntax—where condition applies.
   “Unless” syntax—where condition does not apply.
   Performing “while” loop—examining condition as part of entering into loop.
   Performing “for” loop—performing predetermined number of iterations.
   Performing “for each” loop—performing iteration on data.
   Performing “repeat” loop—performing a loop when the evaluation is performed when each cycle is done.
   Performing “go to” function—With and without conditions.
   Performing “case” comparison.
   Performing “retry” call—re-execute block of code.
   Performing “redo” call—attempt to re-perform function in case of error.
   Supporting operators for data comparison, and bitwise manipulation.
Functions dealing with strings
Mathematical functions
Functions dealing with date and time.

The above options are represented in a graphical manner. They are presented in a user friendly flowchart, enabling the non-technical user, but one who understands the programming concept, to follow the occurrences. For example, the diagram shows how REGEX works:

̂([0−29]{1,})

And its graphical presentation:

As may be seen, it is easier to understand the drawing than comprehending the REGEX expression. Furthermore, the black arrows point to the direction of condition, meaning, to which direction the processing of string will go, since REGEX may be ordered to influence either forwards or backwards. Choosing the proper pattern matching includes the choosing of a proper flowchart element. For example, the command “At least”(1) may be fed with “how many times”. If it refers to once (“2”), the command enables one occurrence of a pattern that is repeated. When referring to minimum one time and maximum 10 times (“3”), the third command enables to feed both values. Those commands enable the thinking in visual approach instead of the following programming language:

{1,} (1)

{1} (2)

{1,10} (3)

Such graphical representation of data helps even advanced users to benefit from such flowcharts, and non-technical users, can write sophisticated REGEX automation.

Since the encapsulation of programming languages is based on a system of flowcharts, the invention provides various types of connectors, representing data flow. For example, a user who is unfamiliar with the term “loop” may receive a circular connector with a condition inside, indicating when to perform the execution, and when to stop. The “break” connector is different from the repeating connector.

Each command that inspects data, such as “case”, has connectors to compare values, and a default action when none was found.

Connectors represent a way of how to deal with data. You can find connections such as:
Direct execution (default option)
Jumping connector (analogous to “go to”)
Boolean connector (analogous to “if”)
Multiplicity choice connector (analogous to “case”)
Circular connection—a choice that change the type of condition whether at the beginning or at the end, to repeat until a Boolean statement allows it to quit (analogous to “while” and “repeat”).
Circular connector with numbering (analogous to “for”)
Circular execution when in error (analogous to “redo”)
Circular execution in case of no respond (analogous to “retry”)

All the above connectors have to be expressed for non-qualified users without the knowledge or understanding of complicated logical functions. Underneath, the functions are translated into the lower level of the encapsulated language.

Containers are the way to assemble certain amount of functions into a group. Logical functions, for example, are kind of containers, grouping various possibilities with connectors. Each function that has to be grouped, “case” for example, includes a container. When user wants to create a group of commands that have to be executed, he has to create such a container. When a certain function directs the flow to the container, the group of commands is applied, and only afterwards, continues to further functions. It is possible to connect a command within a container to an outside function, by a “jumping” connector. By default local variable scope is to the including of a container only. It is possible to transfer values between containers as one expects from functions. Thus, a container has the behavior of a function, receiving “parameters” and returning values.

The programming setting is graphical, enabling the use of graphic elements. The described programming setting works also in a distributed network. It is possible to graphically draw a program element that is actually being implemented by another user on another completely different system. The high level graphic encapsulation allows easy collaborative work by hiding the actual protocols that allow the distribution of data flow and has the option to be augmented to implement any existing or new communication protocols.

The programming setting includes a graphical interactive debugger.

If taking telephony as an example, when applying the debugger, typing the number 1 in IVR during an incoming call applies a predefined checking process that examines if it actually performs the function intended to by user. If it does not, the system stops and warns user. With regard to the graphic representation, the debugger takes into consideration allowing the setting of graphical breakpoints, augmenting the flow through graphical filters and graphically marking debugged areas.

Furthermore, the encapsulation environment knows to warn user, while creating a graphical flowchart, even before activation of the debugger, of any problems with definitions. Such as using non initialized variables, typing incompatibility and other design errors, that can be identified pre execution.

### Manner of Use

The graphic representation of the encapsulating programming is the envelope of an explicit system. Meaning that a graphic drawing and a system knowledgeable of translating the meaning of the graphic object into a collection of commands stand side by side. That collection of commands or the functions capable of being translated and safeguarded as byte code are suitable to various programming languages and have the ability to re-translate the byte code into classical programming language.

The system itself is object oriented. Each programming element in the system is a graphic representation class, knowledgeable of performing certain acts.

Each class includes a special field defining its category. For example, the “case” class has a field defining it as “case”, and each connected class inherited thereof, which does not change that field, belongs to “case”. That way other classes, which are connectors or containers, may be similarly defined.

The classes are flexibly constructed, enabling mixin behavior, creating methods, creating constructor and destructor, and capable of inheritance and override, when needed. The expression “constructor” and “destructor” are fixed, therefore inheritance and override functions may be performed on them as well. It is possible to create a class that functions as a sub-process or thread as long as it has a special component indicating it.

Each object is capable of creating callbacks for functions. Each callback activates a method or another object.

In order to create a graphic representation of a component with ability to receive values, there has to be a method indicating which fields are available in graphic mode. The name of the method has to be unique in order to export the fields. If it does not exist, the graphic component does not present a field to feed. Another method that has to be realized if fields are exported is, a method which sends typing information.

The characteristics of the fields are:
Type of data (integer, character, binary data, additional class and the likes)
Data validation:
   range of numbers
   group of exact values
   templates (like REGEX)
   pre-defined list of values
   value determination in a certain location (e.g. second character has to be A)
   plain text
   null value
   Marking of mandatory fields

If a low level API is created, it is possible to descend to a level similar to a procedural system, however, the user interface will act as an object, and not as a procedural feature.

The system supports anonymous classes. The default execution class is called “MAIN”, and it is undeclared. An anonymous class can have support for mixin on run-time, if a programming language support it.

Each object may have its own namespace, e.g. it is possible to create a namespace, grouping all the functions related to media under “MEDIA”. So, if there are other namespaces with same objects' names, they are distinguished according to the unique additive created by each namespace, thus preventing duplicates.

The object oriented programming implementation enables the creation of inheritance. Inheritance of class enables the change of methods, and is also the inheritance of constructor and destructor.

The graphic representation is itself an object, meaning that the graphic component is to be looked upon as a class with a collection of functions that are translated to methods, when there are fields which define the necessary properties constructor and destructor to initialize and destroy the memory of the object. A method for actual running has to be implemented as well. Within the running method, the necessary functions and methods are called. That is true for connectors as well.

When displaying the graphic representation on screen, instance of class-object is created.

It is possible to perform inheritance and change of class and thus, for example, a class that treats retrieval of value may be parent for input. Input class may be parent for case class etc.

General classes inherit from main class, which defines “class” in general, and is called “object” in most programming languages. It does not have to be formally declared. Meaning, that if it is not, it still includes such inheritance. This is the basic class, which includes the minimal memory management, the ability to define Singleton, to define mandatory fields for realization and various RTTI definitions for class transfer, when necessary.

In case of programming languages, which do not support Object class, like C, the encapsulation system, shall know to translate it and behave accordingly by pointing to the right way to implement it in that language.

When defining an Object, a translation to the programming language it represents, is defined as well. Likewise, a translation into Byte-Code, if it represents a higher level solution such as multiple PBXes, for example.

A GUI class is also predefined in the encapsulation, and when inherited, provides information that it is a GUI class, and how it will be displayed in user interface.

If a class does not inherit from the GUI class, the class will not be displayed at the system.

1. An independent adaptive self-modifying system for conversion of programming languages using graphical objects comprising: graphical interface; common set of graphic icons representing dataflow; variables; different programming levels; expandable external modules; a program flow indicator; connectors; containers; internal byte-code; analysis functions; graphical debugger,

2. The system for conversion of programming languages of claim 1, for object oriented supported and non-objected oriented supported programming languages in such a way that a program or part of it has a dual representation, the original program in any programming language and a graphic representation being an independent programming language representation of the program flow and functions.

3. The system of claim 1 is an object oriented wherein each programming element in the system is an object member of a graphic representation class, knowledgeable of performing certain acts.

4. The graphic representation class of claim 3, wherein a graphic drawing and a system knowledgeable of translating the meaning of the graphic object into a collection of commands stand side by side.

5. The graphical representation of claim 4 wherein the elements that allow a uniform representation of any programming language.

6. The system of claim 1 wherein the system may be expanded by external modules.

7. The system of claim 1, wherein the code behind an object may be written with encapsulation interface or any programming language.

8. The code of claim 7 wherein the encapsulation GUI representing the specific code is defined and may be used with other encapsulated programming languages to perform the same functionality.

9. The system of claim 1 wherein additional external graphical representations may be absorbed provided that graphical objects are represented in the external program to be plugged in the system.

10. The system of claim 1 wherein the system is able to represent several encapsulated programming languages, wherein the same higher level representation may be used to generate programs or interface with systems supporting those languages, independently of the encapsulated language that is used.

11. The system of claim 1 wherein the encapsulation of programming languages is based on a system of flowcharts, wherein the connector has a base class defining its abilities needed only by connectors and any other functionality needed for connection performance such as defining properties etc.

12. The system of claim 1 wherein containers are used to assemble certain amount of functions into a group, wherein container is a specific class being an execution object comprising objects taking care of logic of flow between all objects.

13. The system of claim 1 comprising a virtual machine executing a byte-code translation of the visual representation of the code, such as objects, functions and other programming language representations, and providing a mechanism for having a garbage collection (GC) system and support for system calls.

14. The system of claim 1 comprises three encapsulation levels: the high level enabling the performance of graphical functions for non-technical users, using predefined graphic objects linked by connectors, describing the action flow; the low level enabling the performance of graphical logic functions linked by connectors for technical users, API level enabling to run different commands to construct objects or drawings for use in the highest levels.

15. The system of claim 1 wherein the encapsulation is built for use of minimal typing.

16. The system of claim 1 comprising graphical interactive programming environment, the encapsulation environment knows to warn user, when creating a graphical flowchart, even before activation of the debugger.

17. The system of claim 1 wherein the byte-code integrated in the encapsulation enables debugging and translation to other programming languages using a graphical debugger.
